(19) United States
(12) Patent Application Publication
(10) Pub. No.: US 2014/0006369 A1
(43) Pub. Date: Jan. 2, 2014

(54) PROCESSING STRUCTURED AND UNSTRUCTURED DATA

(71) Applicants: SEAN BLANCHFLOWER, Cambridge (GB); DARREN JOHN GALLAGHER, Cambridge (GB)

(72) Inventors: SEAN BLANCHFLOWER, Cambridge (GB); DARREN JOHN GALLAGHER, Cambridge (GB)

(21) Appl. No.: 13/535,475

(22) Filed: Jun. 28, 2012

(51) Int. Cl. G06F 17/30

(52) U.S. Cl. 707/706; 707/758; 707/E17.058; 707/E17.014

(57) ABSTRACT

In an example implementation, correlative patterns in structured data and in unstructured data are determined, where the determining includes finding a first pattern in the structured data and a second pattern in the unstructured data, and determining a degree of similarity between the first and second patterns. The structured data and unstructured data are processed according to the determined correlative patterns.

### BACKGROUND

Traditional data management systems store data according to a predefined format, such as in relational tables of a database. To retrieve data from a structured database, a database query, such as a Structured Query Language (SQL) query, can be submitted, and data that match criteria in the database query are retrieved from the database tables.

Unstructured data is increasingly becoming more prevalent, both within an enterprise (e.g. business concern, educational organization, government agency) and at publicly-available sites (e.g. websites). In some cases, there can be a larger amount of unstructured data than structured data.

### BRIEF DESCRIPTION OF THE DRAWINGS

Some embodiments are described with respect to the following figures:

FIG. 1 is a block diagram of an example arrangement that incorporates some implementations;

FIG. 2 is a flow diagram of a process according to some implementations; and

FIG. 3 is a block diagram of an example arrangement that includes an intelligent universal search feature according to some implementations.

### DETAILED DESCRIPTION

As the amount of unstructured data has increased, processing requests for data and applying analytics with respect to data has become increasingly more challenging, particularly when the requests and analytics are to be performed with respect to both structured data and unstructured data. Structured and unstructured data can be stored by an enterprise (e.g. business concern, educational organization, government agency, etc.), or the data can be available at publicly-available sites.

Traditionally, structured data can be accessed using database queries, such as Structured Query Language (SQL) queries. The database queries are executed against relational database tables that have formats defined by corresponding data models (also referred to as schemas). The data models define rows and columns of the relational database tables.

Unlike structured data, unstructured data has no predefined data model and does not fit well into the rows and columns of relational database tables. There can be various different types of unstructured data, such as any one or combination of the following: web pages, social media posts (content exchanged using social networking sites), email messages, word processing documents, presentation documents, audio files (e.g. music files, voicemail messages, recorded call center conversations, etc.), video files (e.g. movies, video clips, etc.), text messages, tweets, blogs, news feeds, customer reviews, markup language files (such as Extensible Markup Language (XML) files), and so forth.

Traditional database access techniques based on use of SQL queries cannot be efficiently used to access unstructured data. As a result, the access of both structured and unstructured data can be uncoordinated.

In accordance with some implementations, a processing engine is provided to correlate structured data with unstructured data. Correlation of the structured data and unstructured data allows for access and analytics to be performed with respect to the structured and unstructured data in a more integrated manner. Correlating structured data and unstructured data can refer to determining correlative patterns in the structured data and the unstructured data (discussed further below).

Examples of analytics include any one or combination of the following: processing of the structured and unstructured data to retrieve a subset of data in response to a criterion or criteria in a search request; marketing analysis to determine a strategy for a marketing campaign; sentiment analysis to determine positive or negative user sentiment expressed with respect to an offering (e.g. product or service) of an enterprise; determining rankings of offerings; detecting fraud patterns; and so forth.

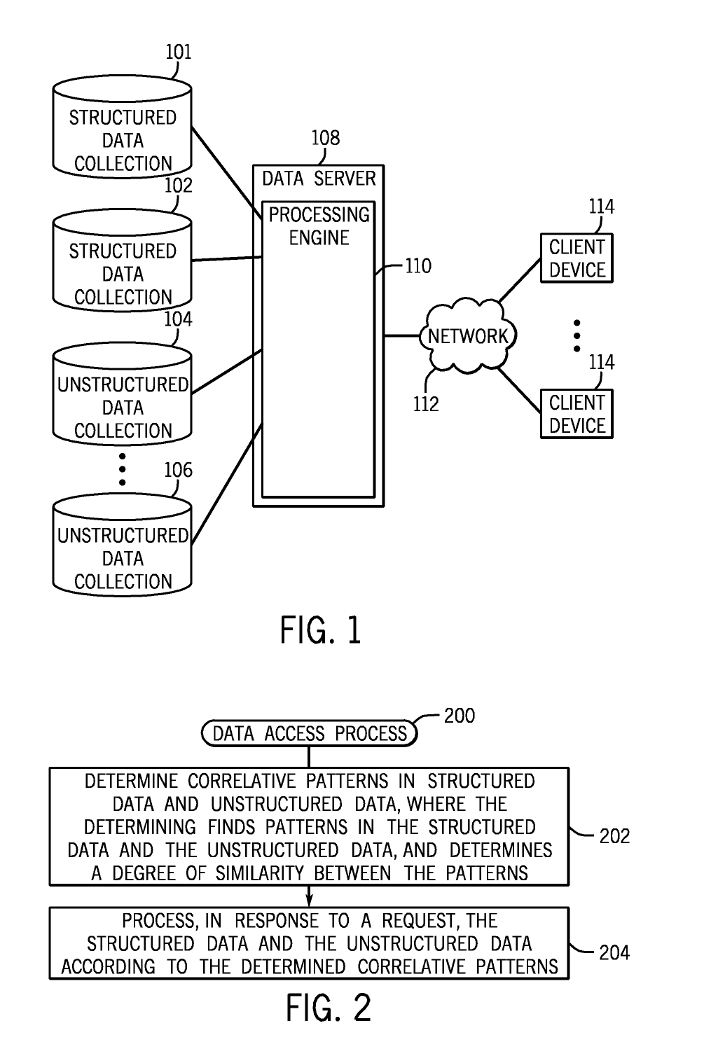

FIG. 1 illustrates an example arrangement that includes structured data collections 101 and 102 and various unstructured data collections 104 and 106. The various unstructured data collections 104 and 106 can represent data collections for different types of unstructured data. For example, the unstructured data collection 104 can be a data collection for an email server that stores email messages. The unstructured data collection 106 can store social media messages. In further examples, other unstructured data collections can be provided. In alternative examples, the various types of unstructured data can be combined into one collection. In other examples, just one structured data collection and one unstructured data collection can be provided.

The structured data collection 101 or 102 can include a relational database that has relational tables according to predefined data models (or schemas). On the other hand, the unstructured data collections 104 and 106 have data items that do not have corresponding data models, but rather, can have many different formats and structures (e.g. free-form text, images, video, etc).

The various data collections 101, 102, 104, and 106 can be stored in one or multiple storage subsystems, which can be implemented with storage devices such as disk-based storage devices or solid state storage devices.

The data collections 101, 102, 104, and 106 are accessible by a data server 108, which can be implemented as a server computer or a collection of server computers. The data server 108 provides users the ability to extract meaning and act on various different forms of data, including the structured and unstructured data in the data collections 101, 102, 104, and 106.

In accordance with some implementations, the data server 108 includes a processing engine 110 that is able to coordinate the access of data in the structured and unstructured data collections 101, 102, 104, and 106. The processing engine 110 can be implemented with machine-readable instructions that are executable in the data server 108. The processing engine 110 is able correlate the structured and unstructured data, and based on such correlation, responsive data can be retrieved from both the structured and unstructured data collections in a coordinated manner. The retrieved data can be subject to further analytics, either by the processing engine 110 or by another module (not shown), which can be part of the data server 108 or part of a different server.

The data server 108 can be connected to a data network 112, which can be an enterprise network (a private network of an enterprise) and/or a public network such as the Internet. Client devices 114 are connected to the network 112, and the client devices 114 are able to access the data server 108 to invoke functionalities of the processing engine 110. Examples of the client devices 114 include computers (e.g. notebook computers, desktop computers, tablet computers, etc.), smartphones, personal digital assistants, game appliances, and so forth.

FIG. 2 is a flow diagram of a process 200 according to some implementations. The process 200 can be performed by the processing engine 110, for example. The process 200 includes determining (at 202) correlative patterns in structured data in a first data collection and in unstructured data in a second data collection. In some implementations, the determination of correlative patterns (referred to as “correlating” or “correlation” in this discussion) includes finding a first pattern in the structured data and a second pattern in the unstructured data, and determining a degree of similarity between the first and second patterns. Generally, patterns found in different data collections may not match exactly. As a result, techniques or mechanisms according to some implementations determine degrees of similarity based on how close (conceptually) the patterns are to each other conceptually. For example, consider the phrase “low-drag wing design expert” as compared to “high-efficiency aerofoil designer.” These words do not match exactly, but they express similar ideas. Techniques or mechanisms according to some implementations can thus determine conceptual distances between different patterns, such as the text strings above.

Patterns can include text, as well as other types of data, such as features in images and video data, features in audio data, and features in other types of data. The ability to determine conceptual distances between patterns can also be applied to the other types of data.

In performing the correlating, the processing engine 110 is able to analyze features of a particular data item, such as a video file, image file, audio file, and so forth. For example, using image and audio analysis techniques that are able to process audio and video signals in real time, the processing engine 110 can include a rich media module to find information with relatively high accuracy. The rich media module can apply rich media processing that involves finding features in rich media, such as video, audio, or image data. Features in a video file or image file can include text, human faces, and/or other elements, which can be used to correlate the video file with other forms of data.

Features of certain types of unstructured data can also include information added by users as part of user consumption (review, exchange, etc.) of unstructured data items, such as blogs, social networking posts, customer reviews, etc. For example, the adding of information can include micro-blogging or social tagging. Micro-blogging (also referred to as micro-posting) allows a user to exchange relatively small elements of content such as short sentences, individual images, or video links. Social tagging refers to tagging social media posts with keywords or other information. In some examples, by using micro-blogging or social tagging, a user can rate helpfulness of a data item (such as with a sliding scale or other scoring technique), the user can add free-text comments or keywords, and so forth.

The determination of conceptual distances between features can also be based on determining contexts of the features. For example, the meaning of a phrase or word can differ depending on the context in which the phrase or word appears. The term “wicked” can mean either good or bad, depending on how the term is used. Thus, in determining a degree of similarity between features, the context of each feature can first be determined to better understand its meaning. Thus, the processing engine 110 is able to better understand the unstructured information by forming a conceptual and contextual understanding of any given data item.

As further depicted in FIG. 2, the structured data and unstructured data can be processed (at 204), in response to a request, according to the correlating. The request can be a request for data matching a criterion or criteria. Since the structured data and unstructured data have been correlated, a search can more quickly be performed with respect to the structured data and unstructured data to find data that is responsive to the request. For example, the request can be a request for U.S. sales for the last quarter. Such request can cause the processing engine 110 to retrieve responsive U.S. sales data from sales-related relational tables in the structured data collection 101 or 102. Moreover, the request can cause the processing engine 110 to access the unstructured data collections 104 and 106 to find possibly responsive data items. The retrieval of data items of the unstructured data collections 104 and 106 to return to the requestor, in response to the request, can be based on the correlation between structured data and unstructured data performed at 202. For example, having identified patterns of data items in the structured data that are responsive to the request, the processing engine 110 can use the correlation between the patterns of data items in the structured data with corresponding patterns in the unstructured data to more efficiently retrieve responsive data items from the unstructured data.

The correlation between structured data and unstructured data can use statistical techniques. For example, a statistical technique can use clustering to find a pattern, and to determine a conceptual distance of that pattern to another pattern or to a concept. Clustering can include K-means clustering, hierarchical agglomerative clustering, or any other appropriate type of clustering technique, to cluster data items into groups that can relate to corresponding concepts. Such clustering can be used for determining a degree of similarity between features of different data items. Distances between clusters can be used for deriving conceptual distances between features in data items in the structured and unstructured data collections, and these conceptual distances can be used for indicating degrees of similarity between the features. Note that a conceptual distance is defined in a concept space, which can be a multi-dimensional space that has axes defined by respective attributes (that make up features) of data items.

In other implementations, other types of statistical techniques can be used. For example, a data item (e.g. text document, video file, etc.) can be analyzed to identify features in the data item. Corresponding weights can be assigned to the features, where a weight can indicate a degree of importance of the corresponding feature in use for computing a conceptual distance.

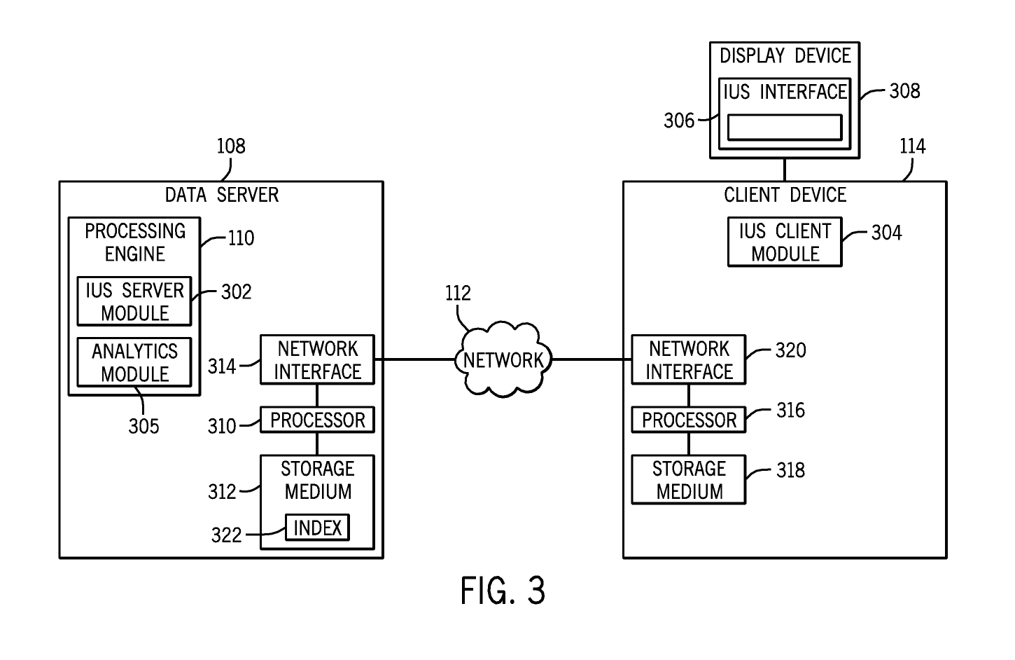

FIG. 3 depicts an example arrangement according to alternative implementations. The example arrangement of FIG. 3 includes an intelligent universal search (IUS) feature that is able to perform various tasks discussed above, including the correlation of structured data and unstructured data in task 204 of FIG. 2. The IUS feature according to some implementations is able to understand richness of unstructured information by forming a conceptual and contextual understanding of any given data item. Based on such understanding, the IUS feature is able to determine conceptual distances between features in the structured data and unstructured data.

In some implementations, the IUS feature also enables user interaction with the structured and unstructured data collections 101, 102, 104, and 106 of FIG. 1. The IUS feature can accept a search input (which can include information in a human-understandable form, a sample data item, etc.), and is able to return results to conceptually related data items.

In examples according to FIG. 3, the IUS feature includes an IUS server module 302, which can be part of the processing engine 110 in the data server 108, and an IUS client module 304, which can be part of a client device 114. Tasks that can be performed by the IUS server module 302 can include analyzing data items (of structured data and unstructured data) to identify features, determining conceptual distances between features, and accessing data in the structured and unstructured data collections to retrieve data items.

The IUS client module 304 can present an IUS interface 306 in a display device 308 of the client device 114. In some examples, the IUS interface 306 can be a web interface. The IUS interface 306 allows for user input and control selections to access functionalities of the IUS server module 302, in accordance with some implementations. The IUS interface 306 can accept user search input of various forms, including SQL queries as well as non-SQL requests.

In some implementations, after a user has entered a user-input search criterion or search criteria relating to data of interest, a search request can be sent to the IUS server module 302, which can trigger the IUS server module 302 to perform correlation of data in the structured data and unstructured data, and to retrieve responsive data items, based on the correlation, from the structured and unstructured data collections.

At least a subset of the responsive data items can be listed in the IUS user interface 306. A user can select one or multiple ones of the listed data items to preview in the IUS interface 306. The selection of a data item(s) to preview can trigger the IUS server module 302 to further retrieve additional data items that may be similar to the previewed data item, again based on the correlation between the structured data and unstructured data. In this way, the user of the IUS interface 306 can be presented with links to data items that are conceptually similar to the one that is being previewed by the user.

The IUS server module 302 and IUS client module 304 can also cooperate to allow users to collaborate and comment on content, such as by use of micro-blogging and social tagging. For example, a user can add tags, free-form text, or other information to particular data items using micro-blogging and social tagging. As noted above, the information added can provide features that can be used to correlate data items in the structured and unstructured data collections.

The IUS server module 302 can also build communities of expertise of users. This is based on forming a conceptual understanding of user interaction with information as the information is consumed and created. Using such conceptual understanding, the IUS server module 302 identifies knowledge (of a user) automatically and in context. In this way, the IUS server module 302 is able to build a conceptual understanding of the relationships between experts and the data items that such experts interact with. As a result, individuals with similar interests and/or expertise can be clustered with corresponding data items. Also, the IUS server module 302 is able to automatically recommend an expert based on an understanding of content of a data item that a user consumes and creates.

The processing engine 110 in the data server 108 can also include an analytics module 305, to perform various analytics tasks as discussed further above. In other implementations, the analytics module 305 can be included in a different server.

As further shown in FIG. 3, the data server 108 includes one or multiple processors 310, which can be coupled to a storage medium (or storage media) 312. The data server 108 also includes a network interface 314 through which communications with the network 112 can be performed. The client device 114 similarly includes one or multiple processors 316, which can be coupled to a storage medium (or storage media) 318. The client device 114 also includes a network interface 320 that allows the client device 114 to communicate over the network 112.

As further shown in FIG. 3, the IUS server module 302 can create an index 322 that is stored in the storage medium (or storage media) 312. The index 322 can be used to correlate data items in the structured data and unstructured data. For example, the index 322 can have multiple entries, where each entry relates a feature (or concept) to respective data items from a structured data collection and data items from an unstructured data collection. By using the index 322, the data items can remain in their original storage locations, such as in the structured and unstructured data collections 101, 102, 104, and 106 of FIG. 1, so that the data items do not have to be moved or copied.

Machine-readable instructions of various modules described above (including 110, 302, 304, and 305 of FIG. 1 or 3) are loaded for execution on a processor or processors (such as 310 or 316 in FIG. 3). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
determining, by a system having a processor, correlative patterns in structured data in a first data collection and in unstructured data in a second data collection, wherein the determining comprises finding a first pattern in the structured data and a second pattern in the unstructured data, and determining a degree of similarity between the first and second patterns; and
processing, in response to a request for data, the structured data and unstructured data according to the determined correlative patterns.

2. The method of claim 1, wherein finding the first and second patterns include using clustering of data items in the structured data and the unstructured data.

3. The method of claim 2, wherein the clustering produces clusters that correspond to respective concepts, and wherein the degree of similarity is based on distances between the clusters.

4. The method of claim 1, further comprising:
presenting a user interface to allow for entry of at least one search criterion to perform retrieval of data items in the structured data and the unstructured data.

5. The method of claim 4, wherein the user interface produces a request according to the at least one search criterion, where the request is a non-Structured Query Language request.

6. The method of claim 4, further comprising:
in response to user selection to preview a data item responsive to the at least one search criterion, retrieving additional data items that are similar, based on the determined correlative patterns, from the structured data and the unstructured data.

7. The method of claim 1, further comprising:
receiving information to add to data items of at least the unstructured data using micro-blogging or social tagging.

8. The method of claim 1, wherein finding the second pattern in the unstructured data comprises finding the second pattern in one or multiple ones of an image file, video file, and audio file.

9. The method of claim 1, wherein finding the second pattern in the unstructured data comprises finding the second pattern in multiple ones selected from among a web page, social media post, email message, word processing document, presentation document, audio file, video file, text message, tweet, blog, news feed, customer review, and markup language file.

10. The method of claim 1, wherein the structured data includes relational database tables.

11. An article comprising at least one machine-readable storage medium storing instructions that upon execution cause a system to:
receive a request for data;
in response to the request, identify data items of structured data responsive to the request;
determine correlative patterns in the identified data items of the structured data and in data items of unstructured data, where the determining comprises finding patterns in the identified data items of the structured data and determining degrees of similarity between the patterns and patterns of data items of the unstructured data; and
retrieve data items from the unstructured data items responsive to the request based on the determined correlative patterns.

12. The article of claim 11, wherein the instructions upon execution cause the system to further:
output the identified data items of the structured data and the retrieved data items of the unstructured data to a requestor in response to the request.

13. The article of claim 12, wherein the instructions upon execution cause the system to further apply analytics on the output data items of the structured data and the retrieved data items of the unstructured data.

14. The article of claim 11, wherein the instructions upon execution cause the system to further:
create an index of data items in the structured data and unstructured data, to allow the structured data and unstructured data to remain in their respective storage locations.

15. The article of claim 11, wherein determining the degrees of similarity comprises determining conceptual distances between features.

16. The article of claim 11, wherein the unstructured data comprises multiple ones selected from among a web page, social media post, email message, word processing document, presentation document, audio file, video file, text message, tweet, blog, news feed, customer review, and markup language file.

17. The article of claim 11, wherein the instructions upon execution cause the system to further:
apply rich media processing to given data items of the unstructured data to identify features in the given data items.

18. A system comprising:
at least one processor to:
determine correlative patterns in structured data in a first data collection and in unstructured data having text and rich media in a second data collection, wherein the determining comprises finding a first pattern in the structured data and a second pattern in the unstructured data, and determining a degree of similarity between the first and second patterns; and
process, in response to a request for data, the structured data and unstructured data according to the correlating.

19. The system of claim 18, wherein the at least one processor is to further:
present a user interface to allow for entry of at least one search criterion to perform retrieval of data items in the structured data and the unstructured data.

20. The system of claim 19, wherein the at least one processor is to further:
in response to user selection to preview a data item responsive to the at least one search criterion, retrieve additional data items that are similar, based on the correlating, from the structured data and the unstructured data.
